(19) United States
(12) Patent Application Publication
(10) Pub. No.: US 2009/0032982 A1
(43) Pub. Date: Feb. 5, 2009

(54) SYSTEM AND METHOD FOR PROVIDING A GAS MIXTURE

(75) Inventors: Frederick W. Giacobbe, Naperville, IL (US); Elizabeth Giacobbe, Naperville, IL (US)

Correspondence Address: AIR LIQUIDE;Intellectual Property, 2700 POST OAK BOULEVARD, SUITE 1800, HOUSTON, TX, 77056, US

(73) Assignee: Air Liquide, Houston, TX (US)

(21) Appl. No.: 11/831,608

(22) Filed: Jul. 31, 2007

(51) Int. Cl. B01F 15/04; B01F 3/02; B01L 5/00

(52) U.S. Cl. 261/128; 261/134; 261/121.1

(57) ABSTRACT

A flow of a gaseous mixture of first and second substances at a desired ratio is provided to a storage container or point of use. Each of the first and second substances has the property of existing only as a gas when it is maintained at one atmosphere and 0° C. A vessel contains the first substance in gas phase only and a second substance in both liquid and gas phases. The second substance is bubbled into the liquid phase of the first substance thereby resulting in the gas mixture in the vessel headspace. The interior vessel temperature, the pressure at which the second substance is bubbled, and a flow rate at which the gas mixture exits the vessel are all maintained at levels sufficient to provide the desired ratio.

### CROSS-REFERENCE TO RELATED APPLICATIONS

None.

### BACKGROUND

A Helium/Carbon Dioxide gas mixture may be used for quenching in vacuum heat treating furnaces. The gas mixture is maintained at elevated pressures and stored in gas cylinders until use. The way the gas mixture is obtained can be problematic because such large volumes of Carbon Dioxide are needed that significant cooling occurs in the Carbon Dioxide gas cylinders during the mixing process. This causes long delays in the gas mixing operation and the need to heat the cylinders to compensate for the cooling effects.

### SUMMARY

A method is disclosed for providing a flow of a gaseous mixture of first and second substances to a storage container or point of use. It includes the following steps. A desired ratio of the first substance to the second substance in the gaseous mixture is selected. A vessel is provided that contains the second substance in a gaseous state and the first substance present in both gaseous and liquid phases. An interior of the vessel has an interior vessel temperature. The first and second substances each has the property of existing only as a gas when it is maintained at one atmosphere and 0° C. A range of interior vessel temperatures to be maintained is selected. The second substance at a second substance pressure is bubbled into the liquid phase of the first substance thereby resulting in a gas mixture of the first and second substances in the vessel headspace. A flow of the gaseous mixture is allowed to exit the vessel at a gas mixture flow rate. The interior vessel temperature, the second substance pressure, and the gas mixture flow rate are maintained at levels sufficient to provide the selected ratio of first substance to second substance in the gas mixture.

A system is provided for providing a flow of a saturated gas mixture of first and second substances to a storage container or point of use. It includes: a vessel containing the first substance in liquid and gaseous phases and the second substance in gaseous phase; a source of the second substance; a pressure regulating device; an inlet conduit in fluid communication with the source of second substance, the pressure regulating device and an interior of the vessel; a sparger contained within the liquid phase of the first substance and being in fluid communication with the inlet conduit; and a heat exchanger operatively associated with the liquid phase of the first substance that is adapted and configured to exchange heat with the liquid phase of the first substance. The first and second substances each has the property of existing only as gases when maintained at one atmosphere and 0° C.

The system and/or method may optionally include one or more of the following aspects:

the first substance is Hydrogen, Nitrogen, Oxygen, Argon, Carbon Dioxide, Krypton, Xenon, Fluorine, Chlorine, Arsine, Boron Trifluoride, Diborane, Phosphine, Germane, Silane, DiSilane, Hydrogen Fluoride, or Hydrogen Chloride

the second substance is selected from the group consisting of Argon, Carbon Dioxide, Chlorine, Fluorine, Helium, Hydrogen, Krypton, Neon, Nitrogen, Oxygen, and Xenon

a set point is selected for the interior vessel temperature and the interior vessel temperature is maintained within a certain number of ° C. around the interior vessel temperature set point

the interior vessel temperature is maintained within 10° C. of the interior vessel temperature setpoint

the interior vessel temperature is maintained within 5° C. of the interior vessel temperature setpoint

the interior vessel temperature is maintained within 1° C. of the interior vessel temperature setpoint

a setpoint for a pressure of the gas mixture in the headspace is selected and the pressure of the gas mixture in the headspace is maintained within a certain number of atmospheres around the selected gas mixture pressure setpoint

the pressure of the gas mixture in the headspace is maintained within 10 atmospheres (absolute) of the selected gas mixture pressure setpoint

the pressure of the gas mixture in the headspace is maintained within 1.0 atmospheres (absolute) of the selected gas mixture pressure setpoint

the pressure of the gas mixture in the headspace is maintained within 0.1 atmospheres (absolute) of the selected gas mixture pressure setpoint

the pressure of the gas mixture in the headspace is maintained within 0.01 atmospheres (absolute) of the selected gas mixture pressure setpoint

a range of interior vessel temperatures is selected within which the interior vessel temperature is to be maintained and the interior vessel temperature is maintained within the selected range by exchanging heat between a heat exchange fluid and the liquid phase of the first substance

the liquid phase of the first substance is heated with a heating element at least partially contained within the vessel

bubbling is performed by sparging.

a maximum desired level of liquid droplets entrained in the gas mixture exiting the vessel is selected and the gas mixture exiting the vessel is allowed to pass through a demisting element adapted and configured to remove a sufficient amount of liquid droplets entrained in the gas mixture exiting the vessel such that the maximum desired level of liquid droplets is not exceeded

the gas mixture exiting the vessel is directed to a container adapted and configured to store compressed gas and the container is filled with a desired amount of the gas mixture

a pressure of the gas mixture in the container after filling is above ambient pressure

a pressure of the gas mixture in the container after filling is below ambient pressure

the first substance is Carbon Dioxide and the second substance is Helium

the flow of gas mixture exiting the vessel is directed to a heat treating furnace

### BRIEF DESCRIPTION OF THE DRAWINGS

For a further understanding of the nature and objects of the present invention, reference should be made to the following detailed description, taken in conjunction with the accompanying drawing, wherein:

The FIG. 1 is a schematic of the disclosed system.

### DESCRIPTION OF PREFERRED EMBODIMENTS

An embodiment of the disclosed method and system concerns precisely blending at least two substances in order to produce a gaseous mixture having a well defined composition that is practically independent of overall gas flow rates as long as these gas flow rates are within design limits associated with the process to be described. In the case of a two substance gas mixture system, the first substance is maintained at temperatures and pressures that cause it to exist in the liquid state. Both the first and second substances exist only as gases when they are maintained at one atmosphere and 0° C. Some non-limiting examples of the first and second substances are listed in Table 1.

TABLE I
Properties of Useful First and Second Substances

| | | | Vapor Pressure/ |
|---|---|---|---|
| | Approx. Critical | Normal Boiling | Temperature |
| Name | Temperature (deg C.) | Point (deg C.) | (atmospheres/° C.) |
| Argon | −122.3 | −185.8 | 1.0/−186 |
| Arsine | 99.9 | −62.4 | 0.41/−80 |
| Boron | 12.2 | −99.8 | 3.33/−80 |
| Trifluoride | | | |
| Carbon | 31.1 | ****** | 5.13/−57 |
| Dioxide | | | |
| Chlorine | 144.0 | −34.0 | 1.00/−34 |
| DiBorane | 16.7 | −92.5 | 1.92/−80 |
| DiSilane | 158.9 | −14.1 | 0.03/−80 |
| Fluorine | −128.8 | −188.2 | 1.0/−188 |
| Germane | 34.9 | −88.1 | 1.50/−80 |
| Hydrogen | −239.9 | −252.7 | 1.0/−253 |
| Hydrogen | 90.0 | −66.7 | 0.46/−80 |
| Bromide | | | |
| Hydrogen | 51.5 | −85.0 | 1.32/−80 |
| Chloride | | | |
| Hydrogen | 188 | 19.5 | 1.0/20 |
| Fluoride | | | |
| Krypton | −63.8 | −153.4 | 1.0/−153 |
| Neon | −228.7 | −246.0 | 1.0/−246 |
| Nitrogen | −146.9 | −195.8 | 1.0/−196 |
| Oxygen | −118.5 | −182.9 | 1.0/−183 |
| Phosphine | 51.6 | −87.7 | 1.48/−80 |
| Silane | −3.4 | −112.1 | 4.57/−80 |
| Xenon | 16.5 | −108.1 | 1.0/−107 |

The disclosed method and system involve passing a stream or dispersion of a normally gaseous fluid, at a controlled temperature and pressure, through the liquefied phase of a substance (also maintained at a controlled temperature and pressure) that does not normally exist in the liquid state thereby producing a gaseous mixture of the two fluids in the headspace above the liquid phase. A substance that is “not a normally liquid chemical material” is one that exists only as a gas at one atmosphere and 0° C.

This resultant mixture will have a well-defined ratio of the two original substances because the original gaseous fluid will become saturated with the vapor of the liquefied substance as it passes therethrough. Allowing the saturated gas mixture to flow out of the saturation system will not change the overall mass ratio of the mixed components even if that gas mixture expands and drops to much lower pressures and/or if it warms up to much higher temperatures than those employed within the saturation system. The flowing gas mixture, either maintained at low temperatures or allowed to increase in temperature and drop in pressure, can be directed into or toward some other device that may require use of the precisely blended gas mixture that has been created in this way, such as a compressed gas container, a subatmospheric pressure gas container or a point of use such as a heat treating furnace.

The best results in terms of producing a constant gas mixture composition, in the gas mixture exiting the headspace, will be achieved by precisely controlling all gas/liquid temperatures and pressures within the saturation system during the saturation process.

Allowing the saturated gas mixture to flow out of the mixing system will not significantly change the overall mass or volumetric ratio of each of the mixed components even if that gas mixture warms up (or is deliberately heated) to higher temperatures and/or drops down to lower pressures than those employed within the saturation vessel. After the saturation process, the flowing gas mixture, either maintained at low temperatures and high pressures, or allowed to warm up and drop in pressure, can be directed into or toward some other device that may require use of the precisely blended gas mixture that has been created in this way.

Almost all common fluids that do not normally exist in the liquid state at ambient, or near ambient, temperatures and pressures can exist in the liquid state at ambient pressures (in the vicinity of 1.0 atmosphere) if they are cooled to low enough temperatures. Pure Carbon Dioxide is at least one exception to this generalization because the liquid phase of this material only exists at low temperatures and at elevated pressures significantly above 1.0 atmosphere. In any case, when most pure fluids are liquefied, they tend to have very well defined vapor pressures at specific temperatures. Therefore, if some other gaseous substance (that is “inert” with respect to the low temperature liquid) is bubbled through the low temperature liquid, that gas will tend to become saturated with the vapor of the cooled liquid. Assuming that the gas entering into the saturation system is controlled at low temperatures so that it equals the liquid temperature within the gas saturation system, the vaporization process will tend to cool the system even further. So, even though the liquefied material is initially controlled at some low temperature, its temperature may drop even further during the gas saturation process. In this case, the gas saturation system may have to be heated slightly in order to maintain good overall and continuous temperature control. On the other hand, if there is a natural “heat leak” into a very low temperature gas saturation system, due to a less than perfect insulation system, continuous cooling of the saturation system may be required even if the gas saturation process itself causes a partial cooling effect.

As best illustrated in the Figure, an exemplary system will now be described. A vessel 1 contains a liquid phase portion 3 of the second substance and a headspace 2 containing a gas mixture of the first and second substances. The second substance from source 4 is associated with pressure regulating device 5 and vessel inlet conduit 6. The second substance is bubbled up into the liquid phase 3 via sparger 7. Bubbles 8 travel up to the headspace 2 thereby creating a gas mixture of the two substances. A flow 9 of the gas mixture exits the vessel 1 for either a storage container or a point of use. While heat exchange device 5 is illustrated as circulating heat exchange fluid in a path through the liquid phase 3, one of ordinary skill in the art will recognize that the device 5 may be horizontally inverted. In other words, some of the liquefied second substance may be circulated through a refrigeration device located outside the vessel 1.

### EXAMPLES

As a first example of the disclosed process, one might imagine a pressure vessel partially filled with pure liquid Oxygen and further that the liquid Oxygen is maintained at its normal boiling point temperature of about −183° C. (actually, this temperature condition will automatically occur within the liquid phase of Oxygen within any container open to the atmosphere, either full or partially full of that liquid). Under these conditions, the vapor pressure of the liquid Oxygen will equal the prevailing atmospheric pressure. If a section of tubing is connected between the headspace in this pressure vessel and a closed valve, opening that valve will not release any of the pure oxygen in the pressure vessel because the internal and external tank pressures will be equal. Now, one may imagine that the valve is closed and the liquid Oxygen tank is pressurized with pure gaseous Helium, and at the same time the temperature of the pressurized system is continuously maintained at −183° C. Furthermore, let the Helium entry point into the tank exist at the bottom of the pressure vessel (which is partially filled with the liquid Oxygen) so that the Helium must bubble up through the mass of the liquid Oxygen in that vessel (this process may occur through a sparging device) before it enters the headspace near the top end of the vessel and also until the final system pressure reaches 10.0 atmospheres. Assuming that the gaseous Helium is completely saturated with Oxygen (due to intimate contact with the liquid Oxygen as it bubbles up through the liquid phase), the gas phase, above the liquid Oxygen, will have an Oxygen partial pressure of 1.0 atmosphere and a Helium partial pressure of 9.0 atmospheres because the presence of the Helium will have no practical effect on the vapor pressure of the liquid Oxygen.

Actually, there is typically a small increase in the vapor pressure of a pure substance that is subjected to very high pressures caused by the presence of another high-pressure substance or by mechanical compression. This is typically referred to as the Poynting effect but in most ordinary situations, this effect is negligible. A vapor pressure lowering effect (usually negligible) can also be caused by the fact that some of the gas bubbled up through the liquid will dissolve in the liquid. However, both of these effects are usually so small that they can be entirely neglected but, even if these effects cannot be neglected, compensations in overall system pressures and temperatures can be made to correct for them.

In any case, getting back to the example above (and neglecting the Poynting effect and solution effects, as well as non-ideal gas effects), if the gas phase mixture, in the headspace above the liquid Oxygen, is allowed to escape very slowly, this mixture will contain concentrations of Oxygen in Helium of 10.0%, by volume, even if that gas mixture heats up and expands appreciably after leaving the gas saturation system. If pure Helium is allowed to enter the bottom of a gas saturation system at a flow rate, temperature, and pressure that serves to compensate for the loss of the gas mixture extracted from the headspace, the extraction process of the constant composition gas mixture can continue until the level of the remaining Oxygen drops too low to allow complete saturation of the Helium. At that point in time, or even during the saturation process, additional liquid Oxygen may be injected into the saturation system in order to keep the liquid level therein constant.

Continuing with the Oxygen/Helium example above, it is easy to see that if a Helium partial pressure of 99.0 atmospheres had been used in this example, the final Oxygen concentration in the Helium would have been 1.0%, by volume. In addition, if the liquid Oxygen/Helium system had been operated at lower or higher temperatures, the partial pressure of the Oxygen (within the saturated gas phase mixture) would have been lower or higher, so system temperatures (as well as overall system pressures) can have a significant influence on the composition of any gas mixture created in this way. The point here is that the composition of any gas mixture that can be created in this way can be very well controlled or “tuned” by controlling the overall operating gas saturation system pressures and temperatures.

As another example of the process described above one may consider another case involving Germane (GeH₄) and Hydrogen. Normally, Germane is a toxic and unstable gas. It is not pyrophoric but it does tend to decompose (and/or burn) easily and there have been instances of more or less spontaneous explosions within cylinders containing pure compressed gaseous Germane at ambient temperatures. In this sense, it behaves a bit like Acetylene. In some instances, Germane is mixed with Hydrogen at concentration levels of about 1.0 to 10.0% (by volume), using more conventional gas blending techniques, and then employed in one or more electronics related processing applications. Employing the saturation process described above in this disclosure, Germane may be liquefied at temperatures below about 35° C. (its critical temperature) and then used to saturate a stream of flowing Hydrogen that can be passed into and through the liquid phase. In one practical application, pure Germane may be cooled to −80° C. and liquefied. Its vapor pressure at that temperature is about 1.5 atmospheres.

If Hydrogen is then passed through the liquefied Germane at this temperature and at a total system pressure of 100 atmospheres, the saturated Hydrogen gas mixture will contain a Germane concentration of about 1.5% (by volume), even if that initial gas mixture warms up and expands after leaving the saturation system. One can also see how a large range of differing concentrations of Germane in Hydrogen can be easily achieved using this process by varying the overall gas saturation system temperatures and pressures. Cooling of a gas saturation system containing liquefied Germane can be easily achieved using a conventional cascaded mechanical cooling system or by using a less conventional cooling system involving the use of pumped fluid heat exchangers in which the pumped fluid is cooled using a Carbon Dioxide snow system, or by using a controlled liquid Nitrogen injection cooling system.

The efficacy of the disclosed system and method depends on several interrelated factors. Among these factors include good temperature control over the gas phase material entering the saturation system as well as good temperature control over the liquid saturant as well as the pressure vessel containing this liquid. There are at least several different means of accomplishing this kind temperature control that are well known in the art. Another important point in applying this kind of process involves controlling the overall gas system pressure and gas flow rate into and out of a particular saturation system. The gas flow out can be very low (even zero) but it cannot be too high or the gas mixture leaving the saturation system will not be fully saturated and otherwise excellent control over the gas phase mixture composition will not be achieved. However, existing literature, within the public domain, is full of techniques that can be used to ensure saturation conditions between gases injected into liquids and the liquids themselves when that is a desired result. Excellent control over the pressure within a flowing gas stream is also well known in this kind of art. In any case, each kind of saturation system can be designed to provide (within specific design limits based upon the design limits of selected operational components) very good control over the gas phase mixture composition at site-specific flow rates of the gas mixtures so produced.

In a preferred embodiment, the temperatures and pressures of the first and second substances are driven by the process conditions for which the gas mixture is intended. In other words, based upon a desired temperature, pressure, and mass flow rate of the gas mixture exiting the vessel, the corresponding variable factors of interior vessel temperature and pressure and second gaseous substance pressure and temperature may be determined that will result in the desired ratio of the two substances in the gas mixture. The easiest way of achieving this goal is to start with a given temperature of the gaseous second substance and adjust its pressure as it is bubbled into the vessel as well as adjust the temperature of the vessel interior.

In a particularly useful application of the disclosed system and method, a mixture of Carbon Dioxide and Helium at a specified ratio may be provided to a heat treating furnace. Using the above techniques, gaseous Helium at a partial pressure of roughly 300 pounds per square inch can be bubbled through a large liquid Carbon Dioxide storage tank that is maintained at 0.0° F. and about 300 pounds per square inch. The gas mixture leaving this system will contain 50% Helium and 50% Carbon Dioxide. This composition will not vary as long as one maintains good control over the system temperature and pressure. One of ordinary skill in the art will realize that this kind of control already exists in conventional bulk liquid Carbon Dioxide tanks using internal refrigeration systems.

Other percentage compositions can easily be obtained by changing the partial pressure of Helium or liquid Carbon Dioxide (in the case of Carbon Dioxide, only temperature control is needed to change its vapor pressure). This process can also be made to be relatively independent of gas flow rate with practically no change in the outlet mixture composition. At very high gas mixture flow rates, the liquid Carbon Dioxide may even have to be heated slightly to compensate for the cooling effects associated with the vaporization process. This can be easy to do by providing a controlled “heat leak” through a heat exchanger located inside of the liquid Carbon Dioxide tank in addition to the heat exchanger used for cooling. This process will also work with Hydrogen gas instead of Helium.

In a big on-site installation, high pressure Helium tube trailers will allow a lot of flexibility. In the case of Hydrogen and Helium, these tube trailers are typically maintained at a pressure of about 6,000 pounds per square inch. Assuming that a liquid Carbon Dioxide source tank is also available at the same site, very high mixture pressures can easily be obtained. However, the liquid Carbon Dioxide source tank (if it is used as the primary mixing chamber) would have to be designed to handle the highest mixing pressure expected as well as refrigeration coils for long term liquid Carbon Dioxide storage and heating coils to keep the liquid Carbon Dioxide remaining in the tanks at a controlled temperature. None of the temperature control aspects of this (whether in heating or cooling) are very difficult. Cooling is typically provided by conventional mechanical refrigeration systems. Heating coils (embedded in the tank) can be operated using electricity.

If liquid Carbon Dioxide is stored at 0.0° F. and about 300 pounds per square inch, the entire tank would have to be pressured with Helium (or Hydrogen, if one wanted to use a Hydrogen/Carbon Dioxide blend instead) up to about 600 pounds per square inch in order to provide partial pressures of 300 pounds per square inch for both the Carbon Dioxide and the Helium. This should pose no problem for a Helium tube trailer source. The gas mixture leaving the system (at about 600 pounds per square inch) could be stored in a conventional buffer tank and then later delivered to a vacuum heat treating furnace (at this initial pressure—600 Psig) for very rapid cooling when needed. With only reasonably good temperature and pressure control one may obtain good control over the composition of the final mixture. An overall desired ratio of two gases in the gas mixture may be easily maintained within one or two percent of the ratio. On-site infrared gas analysis of the Carbon Dioxide concentration in the gas mixture can be used to monitor and control the entire process.

If pressures higher than 600 pounds per square inch are needed, the liquid Carbon Dioxide system would have to be designed to handle temperatures higher than 0.0° F. and the Helium source gas would have to be bubbled (sparged) through the liquid Carbon Dioxide at higher pressures. This can also be accomplished without great difficulty if one starts with a properly “rated” liquid Carbon Dioxide source tank.

The only real mechanical compression involved here is in the initial filling of the liquid Carbon Dioxide tank and the Helium (or Hydrogen) tube trailer, both performed remotely at a gas production site.

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

1. A method for providing a flow of a gaseous mixture of first and second substances to a storage container or point of use, comprising the steps of:
selecting a desired ratio of the first substance to the second substance in the gaseous mixture
providing a vessel containing the second substance in a gaseous state and the first substance present in both gaseous and liquid phases, an interior of the vessel having an interior vessel temperature, the first and second substances each having the property of existing only as a gas when it is maintained at one atmosphere and 0° C.
selecting a range of interior vessel temperatures to be maintained;
bubbling the second substance at a second substance pressure into the liquid phase of the first substance thereby resulting in a gas mixture of the first and second substances in the vessel headspace;
allowing a flow of the gaseous mixture to exit the vessel at a gas mixture flow rate; and
maintaining the interior vessel temperature, the second substance pressure, and the gas mixture flow rate at levels sufficient to provide the selected ratio of first substance to second substance in the gas mixture.

2. The method of claim 1, wherein the first substance is selected from the group consisting of Hydrogen, Nitrogen, Oxygen, Argon, Carbon Dioxide, Krypton, Xenon, Fluorine, Chlorine, Arsine, Boron Trifluoride, Diborane, Phosphine, Germane, Silane, DiSilane, Hydrogen Fluoride, and Hydrogen Chloride.

3. The method of claim 1, wherein the second substance is selected from the group consisting of Argon, Carbon Dioxide, Chlorine, Fluorine, Helium, Hydrogen, Krypton, Neon, Nitrogen, Oxygen, and Xenon.

4. The method of claim 1, further comprising the steps of:
selecting a setpoint for the interior vessel temperature; and
maintaining the interior vessel temperature within 10° C. of the interior vessel temperature setpoint.

5. The method of claim 1, further comprising the steps of:
selecting a setpoint for the interior vessel temperature; and
maintaining the interior vessel temperature within 5° C. of the interior vessel temperature setpoint.

6. The method of claim 1, further comprising the steps of:
selecting a setpoint for the interior vessel temperature; and
maintaining the interior vessel temperature within 1° C. of the interior vessel temperature setpoint.

7. The method of claim 1, further comprising the steps of:
selecting a setpoint for a pressure of the gas mixture in the headspace; and
maintaining the pressure of the gas mixture in the headspace within 10 atmospheres (absolute) of the selected gas mixture pressure setpoint.

8. The method of claim 1, further comprising the steps of:
selecting a setpoint for a pressure of the gas mixture in the headspace; and
maintaining the pressure of the gas mixture in the headspace within 1.0 atmospheres (absolute) of the selected gas mixture pressure setpoint.

9. The method of claim 1, further comprising the steps of:
selecting a setpoint for a pressure of the gas mixture in the headspace; and
maintaining the pressure of the gas mixture in the headspace within 0.1 atmospheres (absolute) of the selected gas mixture pressure setpoint.

10. The method of claim 1, further comprising the steps of:
selecting a setpoint for a pressure of the gas mixture in the headspace; and
maintaining the pressure of the gas mixture in the headspace within 0.01 atmospheres (absolute) of the selected gas mixture pressure setpoint.

11. The method of claim 1, further comprising the steps of:
selecting a range of interior vessel temperatures within which the interior vessel temperature is maintained; and
maintaining the interior vessel temperature within the selected range by exchanging heat between a heat exchange fluid and the liquid phase of the first substance.

12. The method of claim 1, further comprising the step of heating the liquid phase of the first substance with a heating element at least partially contained within the vessel.

13. The method of claim 1, wherein said step of bubbling is performed by sparging.

14. The method of claim 1, further comprising the steps of:
selecting a maximum desired level of liquid droplets entrained in the gas mixture exiting the vessel; and
allowing the gas mixture exiting the vessel to pass through a demisting element adapted and configured to remove a sufficient amount of liquid droplets entrained in the gas mixture exiting the vessel such that the maximum desired level of liquid droplets is not exceeded.

15. The method of claim 1, further comprising the step of directing the gas mixture exiting the vessel to a container adapted and configured to store compressed or subatmospheric pressure gas; and
filling the container with a desired amount of the gas mixture.

16. The method of claim 15, wherein a pressure of the gas mixture in the container after filling is above ambient pressure.

17. The method of claim 15, wherein a pressure of the gas mixture in the container after filling is below ambient pressure.

18. The method of claim 1, wherein the first substance is Carbon Dioxide and the second substance is Helium.

19. The method of claim 18, further comprising the step of directing the flow of gas mixture exiting the vessel to a heat treating furnace.

20. A system for providing a flow of a saturated gas mixture of first and second substances to a storage container or point of use, comprising:
a vessel containing the first substance in liquid and gaseous phases and the second substance in gaseous phase, the first and second substances each having the property of existing only as gases when maintained at one atmosphere and 0° C.
a source of the second substance;
a pressure regulating device;
an inlet conduit in fluid communication with the source of second substance, the pressure regulating device and an interior of the vessel;
a sparger contained within the liquid phase of the first substance and being in fluid communication with the inlet conduit; and
a heat exchanger operatively associated with the liquid phase of the first substance that is adapted and configured to exchange heat with the liquid phase of the first substance.

21. The system of claim 20, wherein the first substance is selected from the group consisting of Hydrogen, Nitrogen, Oxygen, Argon, Carbon Dioxide, Krypton, Xenon, Fluorine, Chlorine, Arsine, Boron Trifluoride, Diborane, Phosphine, Germane, Silane, DiSilane, Hydrogen Fluoride, and Hydrogen Chloride.

22. The system of claim 20, wherein the second substance is selected from the group consisting of Argon, Carbon Dioxide, Chlorine, Fluorine, Helium, Hydrogen, Krypton, Neon, Nitrogen, Oxygen, and Xenon.

23. The system of claim 20, wherein the first substance is Carbon Dioxide and the second substance is Helium.

24. The system of claim 20, wherein the heat exchanger comprises a mechanical refrigeration system.
